(19) United States
(12) Patent Application Publication
(10) Pub. No.: US 2007/0263649 A1
(43) Pub. Date: Nov. 15, 2007

(54) Network diagnostic systems and methods for capturing network messages

(76) Inventors: Genti Cuni, Mountain View, CA (US); Adam H. Schondelmayer, Cupertino, CA (US); Timothy M. Beyers, San Francisco, CA (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/433,236

(22) Filed: May 12, 2006

(51) Int. Cl. H04L 12/56

(52) U.S. Cl. 370/412; 370/252

(57) ABSTRACT

A network diagnostic system may include one or more network diagnostic components. The network diagnostic components may be configured to capture at least a portion of one or more network messages. The network diagnostic components may include a plurality of buffers, and the network diagnostic components may be configured to capture at least a portion of one or more network messages in the buffers. The network diagnostic components may be configured to execute the captures in response to capture trigger. A trigger module may be configured to provide the capture trigger in response to detecting one or more conditions. The trigger module may be configured to provide the capture trigger in response to detecting a statistic that is outside a particular range of values. The trigger module may be configured to provide the capture trigger in response to detecting a change in network configuration data associated with a networking system.

### BACKGROUND OF THE INVENTION

1. Field of the Invention

The present invention generally relates to network diagnostic systems and in particular to network diagnostic systems that may capture network messages.

2. Background Technology

Computer and data communications networks continue to proliferate due to declining costs, increasing performance of computer and networking equipment, and increasing demand for communication bandwidth. Communications networks—including wide area networks (“WANs”), local area networks (“LANs”), metropolitan area networks (“MANs”), and storage area networks (“SANS”)—allow increased productivity and use of distributed computers or stations through the sharing of resources, the transfer of voice and data, and the processing of voice, data and related information at the most efficient locations. Moreover, as organizations have recognized the economic benefits of using communications networks, network applications such as electronic mail, voice and data transfer, host access, and shared and distributed databases are increasingly used as a means to increase user productivity. This increased demand, together with the growing number of distributed computing resources, has resulted in a rapid expansion of the number of installed networks.

As the demand for networks has grown, network technology has developed to the point that many different physical configurations presently exist. Examples include Gigabit Ethernet (“GE”), 10 GE, Fiber Distributed Data Interface (“FDDI”), Fibre Channel (“FC”), Synchronous Optical Network (“SONET”) and InfiniBand networks. These networks, and others, typically conform to one of a variety of established standards, or protocols, which set forth rules that govern network access as well as communications between and among the network resources. Typically, such networks utilize different cabling systems, have different characteristic bandwidths and typically transmit data at different speeds. Network bandwidth, in particular, has been the driving consideration behind many advancements in the area of high speed communication systems, methods and devices.

For example, the ever-increasing demand for network bandwidth has resulted in the development of technology that increases the amount of data that can be pushed through a single channel on a network. Advancements in modulation techniques, coding algorithms and error correction have vastly increased the rates at which data can be transmitted across networks. For example, in years past, the highest rate that data could travel across a network was at about one Gigabit per second. This rate has increased to the point where data can travel across Ethernet and SONET networks at rates as high as 10 gigabits per second, or faster.

As communication networks have increased in size, speed and complexity however, they have become increasingly likely to develop a variety of problems that, in practice, have proven difficult to diagnose and resolve. Such problems are of particular concern in light of the continuing demand for high levels of network operational reliability and for increased network capacity.

The problems generally experienced in network communications can take a variety of forms and may occur as a result of a variety of different circumstances. Examples of circumstances, conditions and events that may give rise to network communication problems include the transmission of unnecessarily small frames of information, inefficient or incorrect routing of information, improper network configuration and superfluous network traffic, to name just a few. Such problems are aggravated by the fact that networks are continually changing and evolving due to growth, reconfiguration and introduction of new network topologies and protocols. Moreover, new network interconnection devices and software applications are constantly being introduced and implemented. Circumstances such as these highlight the need for effective, reliable, and flexible diagnostic mechanisms.

### BRIEF SUMMARY OF EMBODIMENTS OF THE INVENTION

A need therefore exists for systems and methods that eliminate or reduce the disadvantages and problems listed above and/or other disadvantages and problems.

One aspect is a network diagnostic system that may comprise a network diagnostic component. The network diagnostic component may comprise a first buffer, a second buffer, a storage device, and a buffer load module. The buffer load module may be configured to store at least a portion of a plurality of network messages in the first buffer. The buffer load module may be configured to, in response to a first capture trigger, cease storing at least a portion of a plurality of network messages in the first buffer and commence storing at least a portion of a plurality of network messages in the second buffer. The network diagnostic component may also comprise a buffer copy module. The buffer copy module may be configured to, in response to the first capture trigger, copy the at least a portion of a plurality of messages in the first buffer to the storage device.

Another aspect is a network diagnostic system that may comprise a network diagnostic component. The network diagnostic component may comprise a first buffer, a second buffer, a third buffer, a storage device, and a buffer load module. The buffer load module may be configured to store at least a portion of a first plurality of network messages in the first buffer and to store the at least a portion of a first plurality of network messages in the second buffer. The buffer load module may be configured to, in response to a first capture trigger, to store at least a portion of a second plurality of network messages in the first buffer and to store the at least a portion of a second plurality of network messages in the third buffer. The network diagnostic component may also comprise a buffer copy module. The buffer copy module may be configured to, in response to the first capture trigger, copy the at least a portion of a plurality of messages in the second buffer to the storage device.

Yet another aspect is a network diagnostic system that may comprise a network diagnostic component. The network diagnostic component may be configured to, in response to a capture trigger, execute a capture of at least a portion of one or more network messages. The network diagnostic system may also comprise a trigger module. The trigger module may be configured to, in response to detecting a change in network configuration data associated with a networking system, provide the trigger.

For purposes of summarizing, some aspects, advantages, and novel features have been described. Of course, it is to be understood that not necessarily all such aspects, advantages, or features will be embodied in any particular embodiment of the invention. Further, embodiments of the invention may comprise aspects, advantages, or features other than those that have been described. Some aspects, advantages, or features of embodiments of the invention may become more fully apparent from the following description and appended claims or may be learned by the practice of embodiments of the invention as set forth in this disclosure.

### BRIEF DESCRIPTION OF THE DRAWINGS

The appended drawings contain figures of preferred embodiments to further clarify the above and other aspects, advantages and features of the present invention. It will be appreciated that these drawings depict only preferred embodiments of the invention and are not intended to limits its scope. The invention will be described and explained with additional specificity and detail through the use of the accompanying drawings in which:

FIG. 1 is a block diagram of an exemplary embodiment of a networking system, illustrating an exemplary network diagnostic component;

FIG. 2 is a block diagram of an exemplary embodiment of the networking system shown in FIG. 1;

FIG. 3 is a flowchart illustrating an exemplary embodiment of a network diagnostic method;

FIG. 4 is a flowchart illustrating an exemplary embodiment of the network diagnostic method shown in FIG. 3;

FIG. 5 is a flowchart illustrating an exemplary embodiment of a network diagnostic method;

FIG. 6 is a flowchart illustrating an exemplary embodiment of the network diagnostic method shown in FIG. 5;

FIG. 7 is a flowchart illustrating an exemplary embodiment of a network diagnostic method; and

FIG. 8 is a block diagram of the networking system shown in FIG. 1, illustrating the network diagnostic component including a trigger module.

### DETAILED DESCRIPTION OF THE PREFERRED EMBODIMENTS

Certain embodiments relate generally to networking systems, including the testing of high speed data transmission systems and components. Embodiments of the invention may be used in other contexts unrelated to testing systems and components and/or unrelated to high speed data transmission.

### Exemplary Networking System

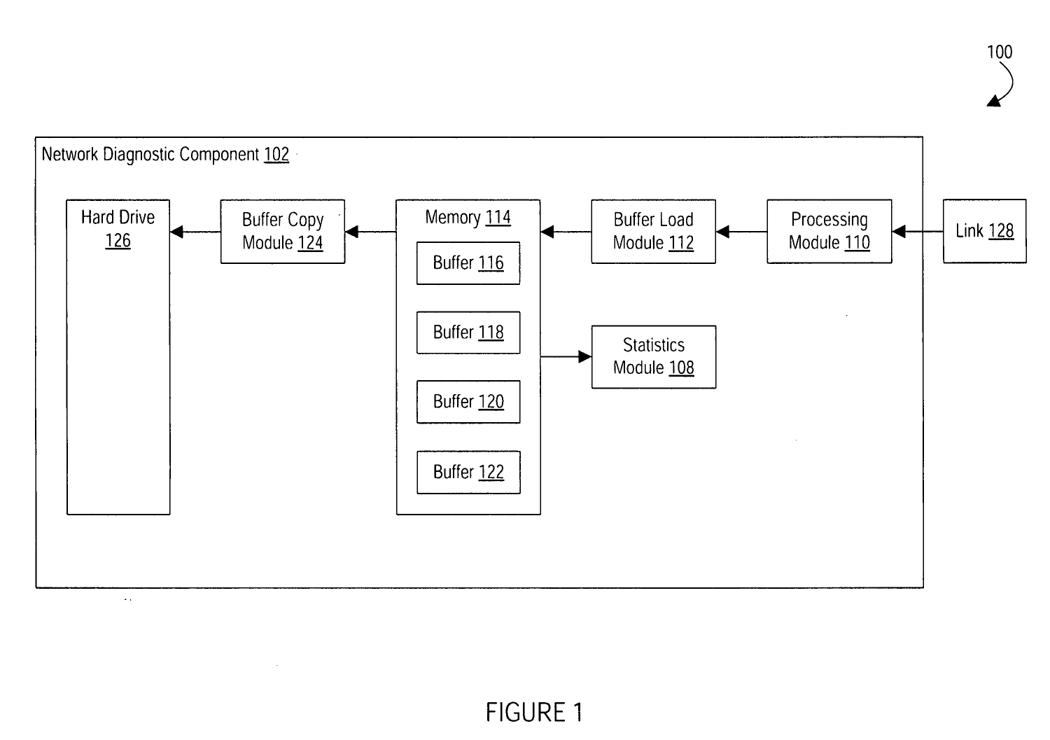

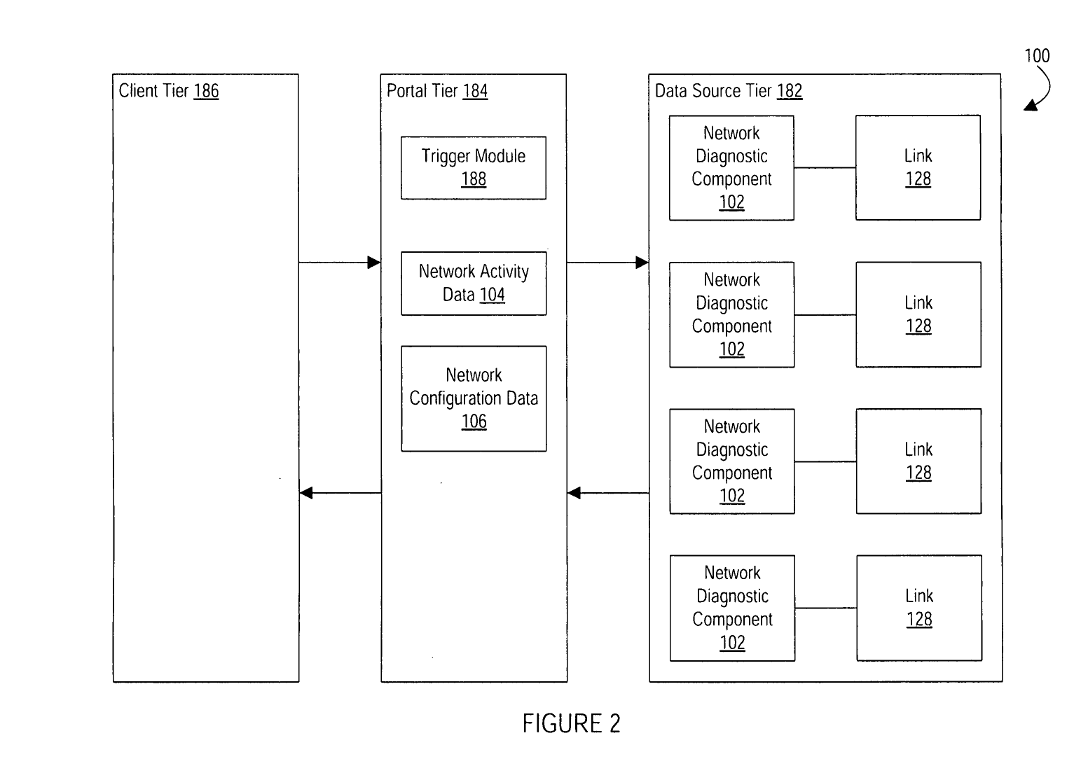

A shown in FIGS. 1 and 2, an exemplary networking system 100 may comprise a network, network diagnostic system, a network testing system, or the like including one or more network diagnostic components (such as, a network diagnostic component 102). In one embodiment, the network diagnostic component 102 may comprise one or more hardware modules, one or more software modules, or both.

The networking system 100 may also include one or more nodes (not shown). As used herein, a “node” includes, but is not limited to, a server; host; a client; storage device; a switch; a hub; a router; all or a portion of a SAN fabric; a diagnostic device; and any device that may be coupled to a network and that may receive and/or monitor a signal or data over at least a portion of a network, that may send and/or generate a signal or data over at least a portion of a network, or both. In one embodiment, a signal (such as, an electrical signal, an optical signal, and the like) may be used to send and/or receive network messages over at least a portion of a network. As used herein, a “network message” includes, but is not limited to, a packet; a datagram; a frame; a data frame; a command frame; an ordered set; any unit of data capable of being routed (or otherwise transmitted) through a computer network; and the like. In one embodiment, a network message may comprise transmission characters used for data purposes, protocol management purposes, code violation errors, and the like. Also, an ordered set may include, a Start of Frame (“SOF”), an End of Frame (“EOF”), an Idle, a Receiver_Ready (“R_RDY”), a Loop Initialization Primitive (“LIP”), an Arbitrate (“ARB”), an Open (“OPN”), and Close (“CLS”)—such as, those used in certain embodiments of Fibre Channel. Of course, any ordered sets and/or any network messages of any other size, type, and/or configuration may be used, including, but not limited to, those from any other suitable protocols. Nodes may communicate using suitable network protocols, including, but not limited to, serial protocols, physical layer protocols, channel protocols, packet-switching protocols, circuit-switching protocols, Ethernet, Fast Ethernet, Gigabit Ethernet, 10 Gigabit Ethernet, Fibre Channel, Fibre Channel Arbitrated Loop (“FC-AL”), Small Computer System Interface (“SCSI”), High Performance Parallel Interface (“HIPPI”), Serial Attached SCSI (“SAS”), Serial ATA (“SATA”), SAS/SATA, Serial SCSI Architecture (“SSA”), and the like.

The network diagnostic component 102 and/or other components of the networking system 100 may perform one or more network diagnostic methods. In performing the network diagnostic methods, the network diagnostic component 102 and/or other components of the networking system 100 may generate network activity data 104; access network activity data 104; access network configuration data 106; perform other processes; or any combination thereof.

### Exemplary Network Activity Data

As mentioned above, the network diagnostic component 102 and/or other components of the networking system 100 may access network activity data 104. The network activity data 104 may be generated by a protocol analyzer, a monitor, and any other appropriate device. In one embodiment, the network diagnostic component 102 may include a statistics module 108, and the statistics module 108 may be configured to function as a protocol analyzer, monitor, or other device to generate the network activity data 104 that the network diagnostic component 102 and/or other components of the networking system 100 access.

Protocol Analyzer

In some embodiments, a protocol analyzer (or network analyzer) may be used to analyze a bit sequence and generate network activity data 104 from that analysis. The bit sequence typically comprises one or more network messages (such as, packets, frames, or other protocol-adapted network messages); and the network activity data 104 generated by the protocol analyzer may include various statistics, for example, one or more counts of various data transmission faults, one or more counts of various transmissions errors, one or more counts of various performance errors (known generally as problem conditions), one or more counts of network messages having particular characteristics, and the like.

To generate the network activity data 104, the protocol analyzer may be configured to compare the bit sequence (or at least a portion thereof) with one or more bit sequences or patterns. Before performing this comparison, the protocol analyzer may optionally apply one or more bit masks to the received bit sequence. In performing this comparison, the protocol analyzer may determine whether all or a portion of the received bit sequence (or the bit-masked version of the received bit sequence) matches and/or does not match the one or more bit patterns. In one embodiment, the bit patterns and/or the bit masks may be configured such that the bit patterns will (or will not) match with a received bit sequence that comprises a network message having particular characteristics—such as, for example, having an unusual network address, having a code violation or character error, having an unusual timestamp, having an incorrect CRC value, indicating a link re-initialization, and/or having a variety of other characteristics.

To generate the network activity data 104, the protocol analyzer may detect a network message having any specified characteristics, which specified characteristics may be user-selected via user input. It will be appreciated that a specified characteristic could be the presence of an attribute or the lack of an attribute. Also, it will be appreciated that the network analyzer may detect a network message having particular characteristics using any other suitable method.

To generate the network activity data 104, the protocol analyzer may optionally be configured to filter network messages (for example, network messages having or lacking particular characteristics), such as, messages from a particular node, messages to a particular node, messages between or among a plurality of particular nodes, network messages of a particular format or type, messages having a particular type of error, and the like. Accordingly, using one or more bit masks, bit patterns, and the like, the protocol analyzer may be used identify network messages having particular characteristics and determine whether to analyze or to discard those network messages based at least in part upon those particular characteristics.

Monitor

In some embodiments, a monitor may be used to generate network activity data 104 comprising statistics derived from one or more network messages having particular characteristics, one or more conversations having particular characteristics, and the like.

To determine the network messages and/or the conversations from which statistics should be derived, the monitor may be configured to compare a bit sequence—such as one or more network messages—with one or more bit sequences or patterns. Before performing this comparison, the monitor may optionally apply one or more bit masks to the bit sequence. In performing this comparison, the monitor may determine whether all or a portion of the bit sequence (or the bit-masked version of the bit sequence) matches and/or does not match the one or more bit patterns. In one embodiment, the bit patterns and/or the bit masks may be configured such that the bit patterns will (or will not) match with a bit sequence (or portion thereof) when the bit sequence comprises a network message from a particular node, a network message to a particular node, a network message between or among a plurality of particular nodes, a network message of a particular format or type, a network message having a particular error, and the like. Accordingly, the monitor may be configured to detect a network message having any specified characteristics—including but not limited to whether the network message is associated with a particular conversation among nodes.

Upon detecting a network message having specified characteristics, the monitor may create and update table entries to maintain statistics for individual network messages and/or for conversations between nodes. For example, a monitor may count the number of physical errors (such as, bit transmission errors, CRC error, and the like), protocol errors (such as, timeouts, missing network messages, retries, out of orders), other error conditions, protocol events (such as, an abort, a buffer-is-full message), and the like. Also, as an example, the monitor may create conversation-specific statistics, such as, the number of packets exchanged in a conversation, the response times associated with the packets exchanged in a conversation, transaction latency, block transfer size, transfer completion status, aggregate throughput, and the like. It will be appreciated that a specified characteristic could be the presence of an attribute or the lack of an attribute.

In some embodiments, the network diagnostic component 102 and/or the statistics module 108 may include any features and/or perform any method described in U.S. patent application Ser. No. 10/769,202, entitled MULTI-PURPOSE NETWORK DIAGNOSTIC MODULES and filed on Jan. 30, 2004, which is hereby incorporated by reference herein in its entirety.

Network activity data may include network activity statistics for various events, types of network messages and the like including, but not limited to, frames/sec [Total number of frames of any type per second]; MB/sec [Total megabytes of frame payload data per second, which preferably does not include the SOF, Header, CRC or EOF]; SCSI MB/sec [Total megabytes of SCSI frame payload data per second. This preferably includes all SCSI Command, Transfer Ready, Data and Status frames]; SCSI Frames/sec [Total number of SCSI frames per second. This preferably includes all SCSI Command, Transfer Ready, Data and Status frames.]; Application Data MB/sec [Total megabytes of Application payload data per second. Application Data preferably refers only to the payload of Solicited and Unsolicited Data frames]; Application Data Frames/sec [Total Application data frames per second. Application Data preferably refers only to the payload of Solicited and Unsolicited Data frames.]; Management MB/sec [Total megabytes of FC Management frame payload data per second. This preferably does not include the SOF, Header, CRC or EOF. This is preferably a count of all Extended Link Services (ELS), Basic Link Services (BLS), Fibre Channel Services (FCS), Link Control (LC) and Fabric Frames (SOF(f))]; Management Frames/sec [Total number of Fibre Channel Management Frames per second. This is preferably a count of all Extended Link Services (ELS), Basic Link Services (BLS), Fibre Channel Services (FCS), Link Control (LC) and Fabric Frames (SOF(f)).]; Other MB/sec [Total mega bytes of Non-Management and Non-SCSI frame payload data per second. Preferably does not include the SOF, Header, CRC or EOF.]; Other Frames/sec [Total number of Non-Management and Non-SCSI frames per second]; Total Capacity % [Amount of overall Bus Capacity utilized in FRAME activity per second. This preferably includes Management, SCSI, and Other capacity.]; Management Capacity % [Amount of overall Bus Capacity utilized in Fibre Channel Management FRAME activity per second.]; SCSI Capacity % [Amount of overall Bus Capacity utilized in SCSI FRAME activity per second.]; Other Capacity % [Amount of overall Bus Capacity utilized in Fibre Channel Management FRAME activity per second.]; Count of Loss of Signal Events; Count of Loss of Sync Events; Count of NOS/OLS Events; Count of LIP w Events; Count of Fibre Channel Link Up Events; Count of LIP or NOS/OLS events; Count of Code Violations; Count of Extended Link Services Frames; Count of Fibre Channel Services Frames; Count of Fabric SOFf Frames; Count of Basic Fibre Channel Link Services; Count of Fibre Channel Link Control Frames; Count of Logins Frames; Count of Logout Frames; Count of Abort Sequence Frames; Count of Notifications [Number of Registered State Change Notification (RSCN) frames plus Fabric Address Notification (FAN) frames]; Count of Reject Frames; Count of Busy Frames; Count of Accept Frames; Count of Loop Initialization Frames; Count of Check Condition Status of Frames; and Count of Other Bad Status Frames; Count of Task Management Frames/sec; Capacity % [Amount of overall Bus Capacity utilized in FRAME activity per second.]; minimum number of pending exchanges in an interval; maximum number of pending exchanges in an interval; number of currently pending exchanges; Read/Write/Other Data Frame/sec; Read/Write/Other Data MB/sec; Read/Write/Other Commands Issued [Total number of SCSI Read/Write/Other Command frames issued in an interval.]; Total Read/Write/Other Exchange Completion Time (ms) [Total time for all the SCSI Read/Write/Other Exchange Commands that completed in an interval.]; Min Read/Write/Other Size [Minimum number of data bytes requested for any SCSI Read/Write/Other Exchange that completed in an interval.]; Max Read/Write/Other Size [Maximum number of data bytes requested for any SCSI Read/Write/Other Exchange that completed in an interval.]; Min Read/Write/Other Exchange Completion Time (ms) [Minimum amount of elapsed time (in milliseconds) for any SCSI Read/Write/Other Exchange that completed in an interval.]; Max Read/Write/Other Exchange Completion Time (ms) [Maximum amount of elapsed time (in milliseconds) for any SCSI Read/Write/Other Exchange that completed in an interval.]; Count of Received bytes; Count of Transmitted bytes; Count of Received frames; Count of Transmitted frames; Count of CRC Errors; Count of Link Resets Received; Count of Link Resets Transmitted; Count of Link Failures; Count of Loss of Signal; Count of Loss of Sync; Count of Class3Discards; and other suitable network activity data disclosed in NetWisdom 2.1 User's Guide (copyright 2005), which is hereby incorporated by reference herein and which available from Finisar Corporation having offices 1389 Moffett Park Drive, Sunnyvale, Calif. 94089-1133, USA.

### Exemplary Network Configuration Data

As mentioned above, the network diagnostic component 102 and/or other components of the networking system 100 may access network configuration data 106. The network configuration data 106 preferably includes configuration data for storage devices, servers, switches and/or other nodes or components of the networking system 100.

The network configuration data 106 related to storage devices may include, but is not limited to, LUN maps, the manufacturer of a storage device, the number of ports on a storage device, the speed of a storage device's ports, the settings of a storage device's ports (such as, operating system type, patch level of operating system), which of a storage device's ports are on which controllers, the number of controllers on a storage device, which volumes are on a storage device, which disk drives are on a volume, the RAID level of a volume, the storage space on a storage device (used and/or available), the number of paths to a volume, and a storage device's software versions or levels.

The network configuration data 106 related to servers may include, but is not limited to, the identity of host bus adapters in a server, the number of ports on a host bus adapter in a server, the identity of the world wide names of the ports on a host bus adapter in a server, the speed of the ports on a host bus adapter in a server, the configuration of the ports on a host bus adapter in a server, the driver versions for the software of a host bus adapter in a server, the settings of the ports on a host bus adapter in a server (such as, operating system type, patch level of operating system), the identity of the LUNs visible to a host bus adapter in a server, the configuration of the server, and the CPU utilization of the server.

The network configuration data 106 related to switches may include, but is not limited to, the manufacturer of a switch, the model of a switch, the software version run by a switch, the number of ports on a switch, the speed of the ports on a switch, which of the ports on a switch are active, which port is connected to which port on a switch, which nodes are connected to which ports on a switch, the topology formed by a switch, and security management information (such as what initiators can communicate to what targets).

It will be appreciated that the network configuration data 106 may include other network configuration data related to storage devices, switches and/or servers. It will also be appreciated that the network configuration data need not be related to storage devices, switches or servers and may be related to other nodes or components of a networking system.

### Exemplary Network Diagnostic Component

As shown in FIG. 1, the network diagnostic component 102 may include a statistics module 108; a processing module 110; a buffer load module 112; a first storage device (such as, memory 114); one or more buffers stored in the first storage device (such as, buffers 1 16, 118, 120, 122); a buffer copy module 124; a second storage device (such as, a hard drive 126); other components; or any combination thereof. As used herein, “storage device” is a broad term and is used in its ordinary meaning and includes, but is not limited to, a hard drive, a tape drive, a redundant array of independent disks (RAID), a floppy disk, a CD-ROM or other optical disk, magnetic disk storage, memory, flash memory, nonvolatile memory (such as, memory with data that remains intact when the power is removed), volatile memory (such as, memory with data that is lost when the power is removed), random access memory (RAM), RAM cache, RAM made using complementary metal oxide semiconductor technology (CMOS RAM), read-only memory (ROM), programmable read-only memory (PROM), eraseable programmable read-only memory (EPROM), electrically eraseable programmable read-only memory (EEPROM), any other suitable computer-readable medium, any combination thereof, and the like. It will be appreciated that the network diagnostic component 102 does not require any of these modules, buffers, or storage devices and that the network diagnostic component may have a variety of other suitable components and configurations.

### Exemplary Capture Methods

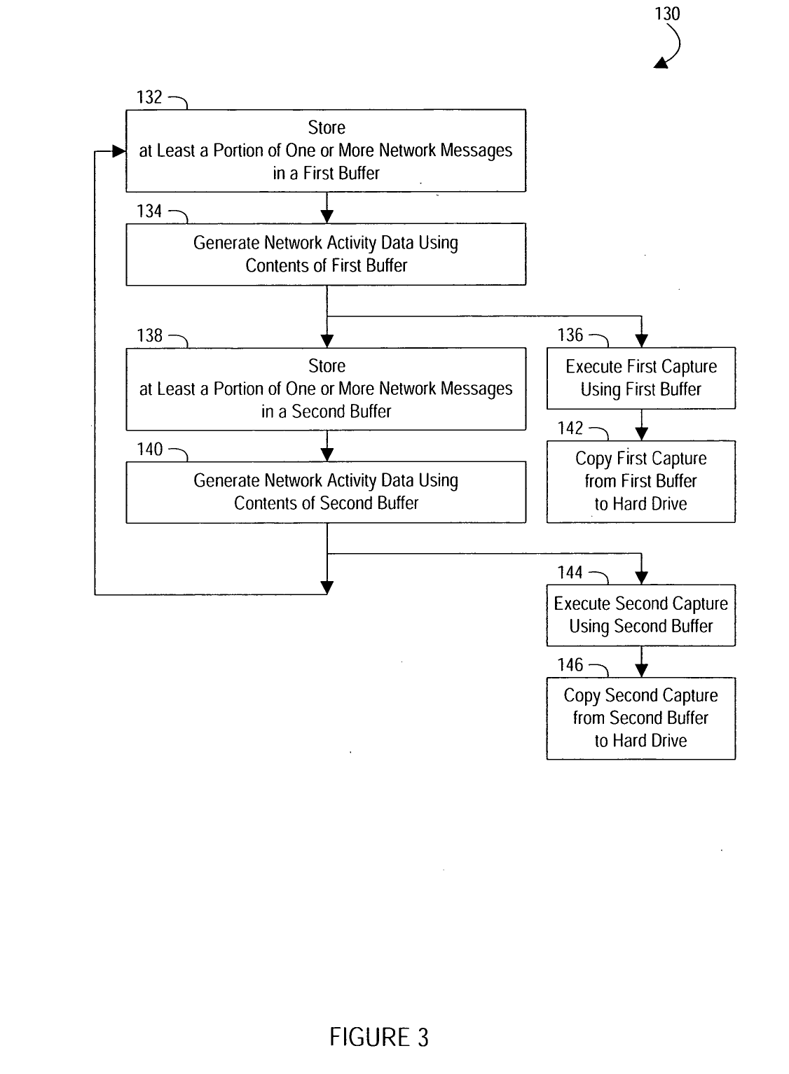

As shown in FIGS. 3-6, the network diagnostic component 102 may generate network activity data 104 with one buffer while executing and/or copying at least one capture with at least one buffer. Preferably, after a buffer has been used to execute and copy a capture, the buffer may be reused. Advantageously, this may allow the network diagnostic component 102 to take one or more captures, while continuing to generate network activity data 104 in a generally interrupted fashion. In addition, as shown in FIGS. 3-6, the network diagnostic component 102 may copy one or more captures to a hard drive, which may allow the captures to be transmitted to another network diagnostic component for additional analysis.

In further detail, as shown in FIG. 1, the network diagnostic component 102 may receive one or more network messages from a link 128. It will be appreciated that the network diagnostic component 102 need not receive network messages from the link 128 and that the network diagnostic component may receive network messages via any other suitable means.

As discussed below with reference to FIGS. 3-6, the buffer load module 112 may store at least a portion of one or more network messages in one or more buffers. In one embodiment, the network diagnostic component 102 may receive one or more network messages, as discussed above; and the buffer load module 112 may store those received network messages in one or more buffers. In one embodiment, the network diagnostic component 102 may receive one or more network messages, as discussed above; and the processing module 110 may process the received network messages, which the buffer load module 112 may store in one or more buffers. To process the received network messages, the processing module 110 may truncate, timestamp, format, and/or otherwise process the received network messages.

As shown in FIG. 3, the network diagnostic component 102 preferably may perform some or all of a network diagnostic method 130; however, some or all of the method 130 may be performed by the network diagnostic component 102; one or more other suitable modules, systems, and the like; or any suitable combination of one or more thereof. Of course, the entire method 130 need not be performed; and any part or parts of the method 130 may be performed to provide a useful method 130.

At a block 132, the buffer load module 112 may store at least a portion of one or more network messages in a first buffer, such as the buffer 116. At the block 132, the buffer load module 112 preferably writes a plurality of network messages (or processed network messages) to the buffer 116 and, at some point, begins overwriting older network messages (or processed network messages) in the buffer 116 with newer network messages (or processed network messages). For example, in one embodiment, the buffer 116 is preferably a circular buffer. It will be appreciated, however, that the buffer 116 need not be a circular buffer.

While the buffer load module 112 performs the block 132, the statistics module 108 may generate network activity data 104 using the contents of the buffer 116 at a block 134. The buffer load module 112 preferably does not overwrite particular contents of the buffer 116 until the statistics module 108 has used those contents to generate the network activity data 104.

As shown in FIG. 3, the network diagnostic component 102 may, at a block 136, execute a first capture using the buffer 116. In one embodiment, the network diagnostic component 102 may execute a capture in response to receiving a capture trigger. The buffer load module 112 may be configured to, upon receipt of the trigger, immediately proceed to the block 138. This may advantageously capture in the buffer 116 the network messages (or processed network messages) stored before receipt of the trigger. The buffer load module 112 may be configured to, upon receipt of the trigger, continue to perform block 132 and then proceed to the block 138. This may advantageously capture in the buffer 116 only network messages (or processed network messages) stored after receipt of the trigger, or this may advantageously may advantageously capture in the buffer 116 both network messages (or processed network messages) stored after receipt of the trigger and network messages (or processed network messages) stored before receipt of the trigger, depending upon the particular configuration of the buffer load module 112.

At the block 138, the buffer load module 112 may store at least a portion of one or more network messages in a second buffer, such as the buffer 118. At the block 138, the buffer load module 112 preferably writes a plurality of network messages (or processed network messages) to the buffer 118 and, at some point, begins overwriting older network messages (or processed network messages) in the buffer 118 with newer network messages (or processed network messages). For example, in one embodiment, the buffer 118 is preferably a circular buffer. It will be appreciated, however, that the buffer 118 need not be a circular buffer.

While the buffer load module 112 performs the block 138, the statistics module 108 may generate network activity data 104 using the contents of the buffer 118 at the block 140. The buffer load module 112 preferably does not overwrite particular contents of the buffer 118 until the statistics module 108 has used those contents to generate the network activity data 104.

While the buffer load module 112 performs the block 138 and the statistics module 108 performs the block 140, the buffer copy module 124 may copy the first capture from the buffer 116 to the hard drive 126 at the block 142. After the buffer copy module 124 copies the first capture from the buffer 116 to the hard drive, the buffer 116 may be available for reuse, for example, when the method 130 returns to the block 132. If desired, the network diagnostic component 102 may transmit the first capture from the hard drive 126 to another network diagnostic component for further analysis.

As shown in FIG. 3, the network diagnostic component 102 may, at a block 144, execute a second capture using the buffer 118. In one embodiment, the network diagnostic component 102 may execute a capture in response to receiving a capture trigger. The buffer load module 112 may be configured to, upon receipt of the trigger, immediately proceed to the block 132. This may advantageously capture in the buffer 118 the network messages (or processed network messages) stored before receipt of the trigger. The buffer load module 112 may be configured to, upon receipt of the trigger, continue to perform block 138 and then proceed to the block 132. This may advantageously capture in the buffer 118 only network messages (or processed network messages) stored after receipt of the trigger, or this may advantageously may advantageously capture in the buffer 118 both network messages (or processed network messages) stored after receipt of the trigger and network messages (or processed network messages) stored before receipt of the trigger, depending upon the particular configuration of the buffer load module 112.

While the buffer load module 112 performs the block 132, the statistics module 108 may generate network activity data 104 using the contents of the buffer 116 at a block 134. While the buffer load module 112 performs the block 132 and the statistics module 108 performs the block 134, the buffer copy module 124 may copy the second capture from the buffer 118 to the hard drive 126 at the block 146. After the buffer copy module 124 copies the second capture from the buffer 118 to the hard drive, the buffer 118 may be available for reuse, for example, when the method 130 returns to the block 138. If desired, the network diagnostic component 102 may transmit the second capture from the hard drive 126 to another network diagnostic component for further analysis.

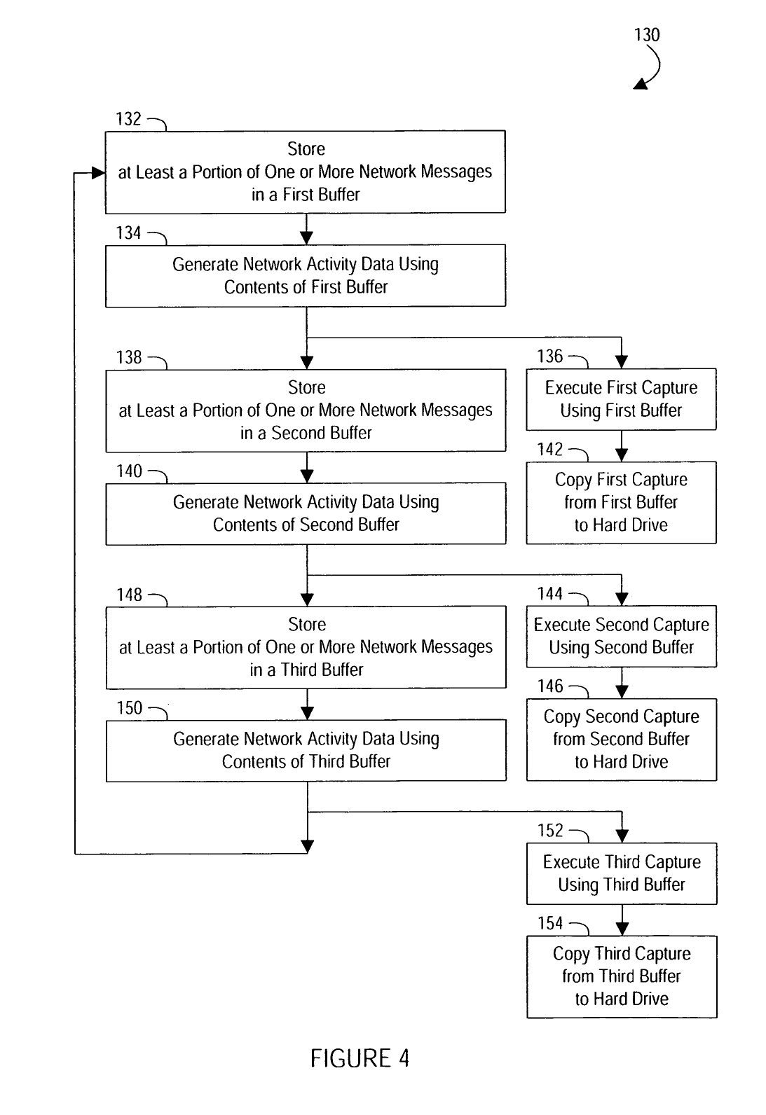

As shown in FIG. 3, the network diagnostic component 102 may generate network activity data 104 with one buffer while executing and/or copying a capture with another buffer. As shown in FIG. 4, the method 130 may be expanded by using one or more additional buffers, which may allow the network diagnostic component 102 to generate network activity data 104 with one buffer while executing and/or copying one or more captures with one or more other buffers. It will be appreciated that the method 130 may be expanded by using two, three, four or more additional buffers, if desired.

In further detail, the network diagnostic component 102 may, at a block 144, execute a second capture using the buffer 118. In one embodiment, the network diagnostic component 102 may execute a capture in response to receiving a capture trigger. The buffer load module 112 may be configured to, upon receipt of the trigger, immediately proceed to the block 148. This may advantageously capture in the buffer 118 the network messages (or processed network messages) stored before receipt of the trigger. The buffer load module 112 may be configured to, upon receipt of the trigger, continue to perform block 138 and then proceed to the block 148. This may advantageously capture in the buffer 118 only network messages (or processed network messages) stored after receipt of the trigger, or this may advantageously may advantageously capture in the buffer 118 both network messages (or processed network messages) stored after receipt of the trigger and network messages (or processed network messages) stored before receipt of the trigger, depending upon the particular configuration of the buffer load module 112.

As shown in FIG. 4, at the block 148, the buffer load module 112 may store at least a portion of one or more network messages in a third buffer, such as the buffer 120. At the block 148, the buffer load module 112 preferably writes a plurality of network messages (or processed network messages) to the buffer 120 and, at some point, begins overwriting older network messages (or processed network messages) in the buffer 120 with newer network messages (or processed network messages). For example, in one embodiment, the buffer 120 is preferably a circular buffer. It will be appreciated, however, that the buffer 120 need not be a circular buffer.

While the buffer load module 112 performs the block 148, the statistics module 108 may generate network activity data 104 using the contents of the buffer 120 at the block 150. The buffer load module 112 preferably does not overwrite particular contents of the buffer 120 until the statistics module 108 has used those contents to generate the network activity data 104.

While the buffer load module 112 performs the block 148 and the statistics module 108 performs the block 150, the buffer copy module 124 may copy the second capture from the buffer 118 to the hard drive 126 at the block 146. After the buffer copy module 124 copies the first capture from the buffer 118 to the hard drive, the buffer 118 may be available for reuse, for example, when the method 130 returns to the block 138. If desired, the network diagnostic component 102 may transmit the second capture from the hard drive 126 to another network diagnostic component for further analysis.

As shown in FIG. 4, the network diagnostic component 102 may, at a block 152, execute a third capture using the buffer 120. In one embodiment, the network diagnostic component 102 may execute a capture in response to receiving a capture trigger. The buffer load module 112 may be configured to, upon receipt of the trigger, immediately proceed to the block 132. This may advantageously capture in the buffer 120 the network messages (or processed network messages) stored before receipt of the trigger. The buffer load module 112 may be configured to, upon receipt of the trigger, continue to perform block 148 and then proceed to the block 132. This may advantageously capture in the buffer 120 only network messages (or processed network messages) stored after receipt of the trigger, or this may advantageously may advantageously capture in the buffer 120 both network messages (or processed network messages) stored after receipt of the trigger and network messages (or processed network messages) stored before receipt of the trigger, depending upon the particular configuration of the buffer load module 112.

While the buffer load module 112 performs the block 132, the statistics module 108 may generate network activity data 104 using the contents of the buffer 116 at a block 134. While the buffer load module 112 performs the block 132 and the statistics module 108 performs the block 134, the buffer copy module 124 may copy the third capture from the buffer 120 to the hard drive 126 at the block 154. After the buffer copy module 124 copies the third capture from the buffer 120 to the hard drive, the buffer 120 may be available for reuse, for example, when the method 130 returns to the block 148. If desired, the network diagnostic component 102 may transmit the third capture from the hard drive 126 to another network diagnostic component for further analysis.

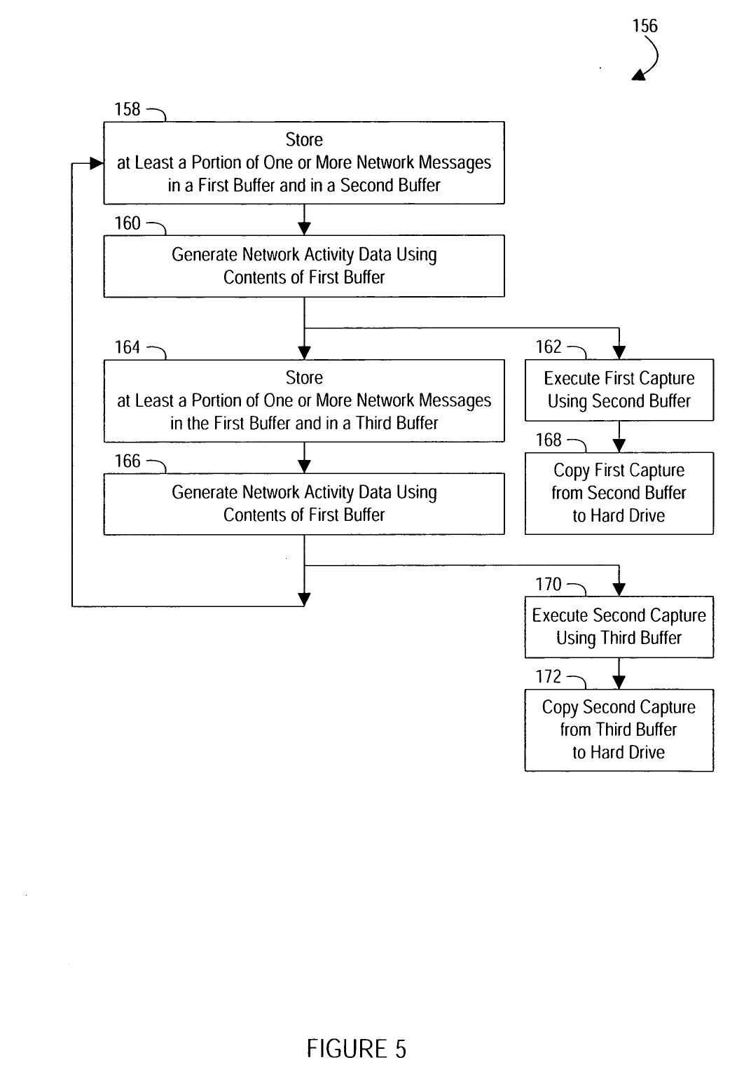

As shown in FIG. 5, the network diagnostic component 102 preferably may perform some or all of a network diagnostic method 156; however, some or all of the method 156 may be performed by the network diagnostic component 102; one or more other suitable modules, systems, and the like; or any suitable combination of one or more thereof. Of course, the entire method 156 need not be performed; and any part or parts of the method 156 may be performed to provide a useful method 156.

At a block 158, the buffer load module 112 may store at least a portion of one or more network messages in a first buffer, such as the buffer 116, and a second buffer, such as the buffer 118. In particular, the buffer load module 112 preferably stores the same or generally the same network messages (or processed network messages) to both of the buffers 116, 118. Accordingly, the buffer 118 may be a mirror of the buffer 116, if desired. The buffer 118, however, need not be an exact mirror of the buffer 116. In fact, in one embodiment, at the block 158, the buffer load module 112 may store at least a portion of one or more network messages in the buffer 116 and the buffer 118 and may also store at least a portion of one or more additional network messages in the buffer 118. For example, at the block 158, the buffer load module 112 may store at least a portion of one or more network messages (or processed network messages) of a first type, such as data frames, in both the buffer 116 and the buffer 118 and may also store at least a portion of one or more network messages (or processed network messages) of one or more other types, such as command frames, control frames, ordered sets, etc., in the buffer 118. Similarly, in one embodiment, at the block 158, the buffer load module 112 may store at least a portion of one or more network messages in the buffer 116 and the buffer 118 and may also store at least a portion of one or more additional network messages in the buffer 116. For example, at the block 158, the buffer load module 112 may store at least a portion of one or more network messages (or processed network messages) of a first type in both the buffer 116 and the buffer 118 and may also store at least a portion of one or more network messages (or processed network messages) of one or more other types in the buffer 116. By allowing the buffers 116, 118 to share some network messages (or processed network messages) in common but optionally include additional network messages (or processed network messages), the contents of the buffers 116, 118 may be customized. For example, the contents of the buffer 116 may comprise a first set of network messages (or processed network messages) customized for the use of the statistics module 108; and the contents of the buffer 118 may comprise a second set of network messages (or processed network messages) customized for a desired capture.

At the block 158, the buffer load module 112 preferably writes a plurality of network messages (or processed network messages) to the buffers 116, 118 and, at some point, begins overwriting older network messages (or processed network messages) in the buffers 116, 118 with newer network messages (or processed network messages). For example, in one embodiment, the buffers 116, 118 are preferably circular buffers. It will be appreciated, however, that the buffers 116, 118 need not be circular buffers.

While the buffer load module 112 performs the block 158, the statistics module 108 may generate network activity data 104 using the contents of the buffer 116 at a block 160. The buffer load module 112 preferably does not overwrite particular contents of the buffer 116 until the statistics module 108 has used those contents to generate the network activity data 104. The buffer load module 112 may overwrite the contents of the buffer 118 before the statistics module 108 has used the contents of the buffer 116 to generate the network activity data 104, if desired.

As shown in FIG. 5, the network diagnostic component 102 may, at a block 162, execute a first capture using the buffer 118. In one embodiment, the network diagnostic component 102 may execute a capture in response to receiving a capture trigger. The buffer load module 112 may be configured to, upon receipt of the trigger, immediately proceed to the block 164. This may advantageously capture in the buffer 118 the network messages (or processed network messages) stored before receipt of the trigger. The buffer a load module 112 may be configured to, upon receipt of the trigger, continue to perform block 158 and then proceed to the block 164. This may advantageously capture in the buffer 118 only network messages (or processed network messages) stored after receipt of the trigger, or this may advantageously may advantageously capture in the buffer 118 both network messages (or processed network messages) stored after receipt of the trigger and network messages (or processed network messages) stored before receipt of the trigger, depending upon the particular configuration of the buffer load module 112.

At a block 164, the buffer load module 112 may store at least a portion of one or more network messages in the buffer 116 and a third buffer, such as the buffer 120. In particular, the buffer load module 112 preferably stores the same or generally the same network messages (or processed network messages) to both of the buffers 116, 120. Accordingly, the buffer 120 may be a mirror of the buffer 116, if desired. The buffer 120, however, need not be an exact mirror of the buffer 116. In fact, in one embodiment, at the block 164, the buffer load module 112 may store at least a portion of one or more network messages in the buffer 116 and the buffer 120 and may also store at least a portion of one or more additional network messages in the buffer 120. For example, at the block 164, the buffer load module 112 may store at least a portion of one or more network messages (or processed network messages) of a first type, such as data frames, in both the buffer 116 and the buffer 120 and may also store at least a portion of one or more network messages (or processed network messages) of one or more other types, such as command frames, control frames, ordered sets, etc., in the buffer 120. Similarly, in one embodiment, at the block 164, the buffer load module 112 may store at least a portion of one or more network messages in the buffer 116 and the buffer 120 and may also store at least a portion of one or more additional network messages in the buffer 116. For example, at the block 164, the buffer load module 112 may store at least a portion of one or more network messages (or processed network messages) of a first type in both the buffer 116 and the buffer 120 and may also store at least a portion of one or more network messages (or processed network messages) of one or more other types in the buffer 116. By allowing the buffers 116, 120 to share some network messages (or processed network messages) in common but optionally include additional network messages (or processed network messages), the contents of the buffers 116, 120 may be customized. For example, the contents of the buffer 116 may comprise a first set of network messages (or processed network messages) customized for the use of the statistics module 108; and the contents of the buffer 120 may comprise a second set of network messages (or processed network messages) customized for a desired capture.

At the block 164, the buffer load module 112 preferably writes a plurality of network messages (or processed network messages) to the buffers 116, 120 and, at some point, begins overwriting older network messages (or processed network messages) in the buffers 116, 120 with newer network messages (or processed network messages). For example, in one embodiment, the buffers 116, 120 are preferably circular buffers. It will be appreciated, however, that the buffers 116, 120 need not be circular buffers.

While the buffer load module 112 performs the block 164, the statistics module 108 may generate network activity data 104 using the contents of the buffer 116 at the block 166. The buffer load module 112 preferably does not overwrite particular contents of the buffer 116 until the statistics module 108 has used those contents to generate the network activity data 104. The buffer load module 112 may overwrite the contents of the buffer 120 before the statistics module 108 has used the contents of the buffer 116 to generate the network activity data 104, if desired.

While the buffer load module 112 performs the block 164 and the statistics module 108 performs the block 166, the buffer copy module 124 may copy the first capture from the buffer 118 to the hard drive 126 at the block 168. After the buffer copy module 124 copies the first capture from the buffer 118 to the hard drive, the buffer 118 may be available for reuse, for example, when the method 156 returns to the block 158. If desired, the network diagnostic component 102 may transmit the first capture from the hard drive 126 to another network diagnostic component for further analysis.

As shown in FIG. 5, the network diagnostic component 102 may, at a block 170, execute a second capture using the buffer 120. In one embodiment, the network diagnostic component 102 may execute a capture in response to receiving a capture trigger. The buffer load module 112 may be configured to, upon receipt of the trigger, immediately proceed to the block 158. This may advantageously capture in the buffer 120 the network messages (or processed network messages) stored before receipt of the trigger. The buffer load module 112 may be configured to, upon receipt of the trigger, continue to perform block 164 and then proceed to the block 158. This may advantageously capture in the buffer 120 only network messages (or processed network messages) stored after receipt of the trigger, or this may advantageously may advantageously capture in the buffer 120 both network messages (or processed network messages) stored after receipt of the trigger and network messages (or processed network messages) stored before receipt of the trigger, depending upon the particular configuration of the buffer load module 112.

While the buffer load module 112 performs the block 158, the statistics module 108 may generate network activity data 104 using the contents of the buffer 116 at a block 160. While the buffer load module 112 performs the block 158 and the statistics module 108 performs the block 160, the buffer copy module 124 may copy the second capture from the buffer 120 to the hard drive 126 at the block 172. After the buffer copy module 124 copies the second capture from the buffer 120 to the hard drive, the buffer 120 may be available for reuse, for example, when the method 156 returns to the block 164. If desired, the network diagnostic component 102 may transmit the second capture from the hard drive 126 to another network diagnostic component for further analysis.

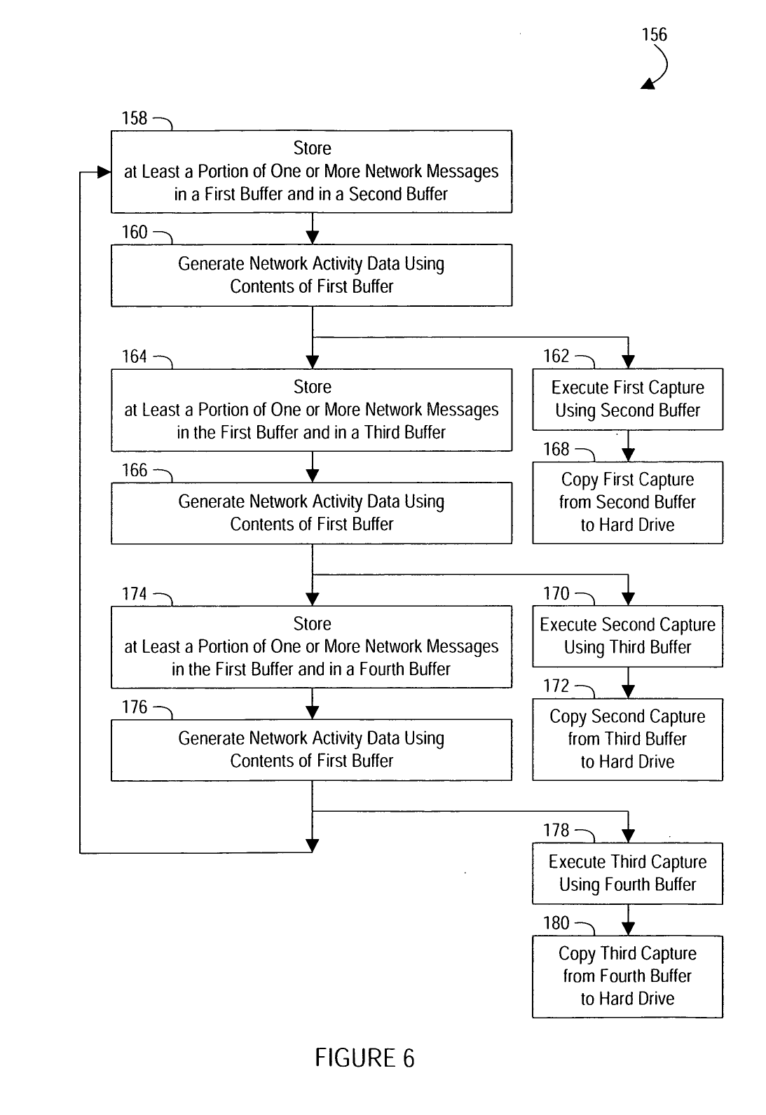

As shown in FIG. 5, the network diagnostic component 102 may generate network activity data 104 with one buffer while executing and/or copying a capture with another buffer. As shown in FIG. 6, the method 156 may be expanded by using one or more additional buffers, which may allow the network diagnostic component 102 to generate network activity data 104 with one buffer while executing and/or copying one or more captures with one or more other buffers. It will be appreciated that the method 156 may be expanded by using two, three, four or more additional buffers, if desired.

In further detail, the network diagnostic component 102 may, at a block 170, execute a second capture using the buffer 120. In one embodiment, the network diagnostic component 102 may execute a capture in response to receiving a capture trigger. The buffer load module 112 may be configured to, upon receipt of the trigger, immediately proceed to the block 174. This may advantageously capture in the buffer 120 the network messages (or processed network messages) stored before receipt of the trigger. The buffer load module 112 may be configured to, upon receipt of the trigger, continue to perform block 164 and then proceed to the block 174. This may advantageously capture in the buffer 120 only network messages (or processed network messages) stored after receipt of the trigger, or this may advantageously may advantageously capture in the buffer 120 both network messages (or processed network messages) stored after receipt of the trigger and network messages (or processed network messages) stored before receipt of the trigger, depending upon the particular configuration of the buffer load module 112.

At a block 174, the buffer load module 112 may store at least a portion of one or more network messages in the buffer 116 and a fourth buffer, such as the buffer 122. In particular, the buffer load module 112 preferably stores the same or generally the same network messages (or processed network messages) to both of the buffers 116, 122. Accordingly, the buffer 122 may be a mirror of the buffer 116, if desired. The buffer 122, however, need not be an exact mirror of the buffer 116. In fact, in one embodiment, at the block 174, the buffer load module 112 may store at least a portion of one or more network messages in the buffer 116 and the buffer 122 and may also store at least a portion of one or more additional network messages in the buffer 122. For example, at the block 174, the buffer load module 112 may store at least a portion of one or more network messages (or processed network messages) of a first type, such as data frames, in both the buffer 116 and the buffer 122 and may also store at least a portion of one or more network messages (or processed network messages) of one or more other types, such as command frames, control frames, ordered sets, etc., in the buffer 122. Similarly, in one embodiment, at the block 174, the buffer load module 112 may store at least a portion of one or more network messages in the buffer 116 and the buffer 122 and may also store at least a portion of one or more additional network messages in the buffer 116. For example, at the block 174, the buffer load module 112 may store at least a portion of one or more network messages (or processed network messages) of a first type in both the buffer 116 and the buffer 122 and may also store at least a portion of one or more network messages (or processed network messages) of one or more other types in the buffer 116. By allowing the buffers 116, 122 to share some network messages (or processed network messages) in common but optionally include additional network messages (or processed network messages), the contents of the buffers 116, 122 may be customized. For example, the contents of the buffer 116 may comprise a first set of network messages (or processed network messages) customized for the use of the statistics module 108; and the contents of the buffer 122 may comprise a second set of network messages (or processed network messages) customized for a desired capture.

At the block 174, the buffer load module 112 preferably writes a plurality of network messages (or processed network messages) to the buffers 116, 122 and, at some point, begins overwriting older network messages (or processed network messages) in the buffers 116, 122 with newer network messages (or processed network messages). For example, in one embodiment, the buffers 116, 122 are preferably circular buffers. It will be appreciated, however, that the buffers 116, 122 need not be circular buffers.

While the buffer load module 112 performs the block 174, the statistics module 108 may generate network activity data 104 using the contents of the buffer 116 at the block 176. The buffer load module 112 preferably does not overwrite particular contents of the buffer 116 until the statistics module 108 has used those contents to generate the network activity data 104. The buffer load module 112 may overwrite the contents of the buffer 122 before the statistics module 108 has used the contents of the buffer 116 to generate the network activity data 104, if desired.

While the buffer load module 112 performs the block 174 and the statistics module 108 performs the block 176, the buffer copy module 124 may copy the second capture from the buffer 120 to the hard drive 126 at the block 172. After the buffer copy module 124 copies the second capture from the buffer 120 to the hard drive, the buffer 120 may be available for reuse, for example, when the method 156 returns to the block 164. If desired, the network diagnostic component 102 may transmit the second capture from the hard drive 126 to another network diagnostic component for further analysis.

As shown in FIG. 6, the network diagnostic component 102 may, at a block 178, execute a third capture using the buffer 122. In one embodiment, the network diagnostic component 102 may execute a capture in response to receiving a capture trigger. The buffer load module 112 may be configured to, upon receipt of the trigger, immediately proceed to the block 158. This may advantageously capture in the buffer 122 the network messages (or processed network messages) stored before receipt of the trigger. The buffer load module 112 may be configured to, upon receipt of the trigger, continue to perform block 174 and then proceed to the block 158. This may advantageously capture in the buffer 122 only network messages (or processed network messages) stored after receipt of the trigger, or this may advantageously may advantageously capture in the buffer 122 both network messages (or processed network messages) stored after receipt of the trigger and network messages (or processed network messages) stored before receipt of the trigger, depending upon the particular configuration of the buffer load module 112.

While the buffer load module 112 performs the block 158, the statistics module 108 may generate network activity data 104 using the contents of the buffer 116 at a block 160. While the buffer load module 112 performs the block 158 and the statistics module 108 performs the block 160, the buffer copy module 124 may copy the third capture from the buffer 122 to the hard drive 126 at the block 180. After the buffer copy module 124 copies the third capture from the buffer 120 to the hard drive, the buffer 122 may be available for reuse, for example, when the method 156 returns to the block 174. If desired, the network diagnostic component 102 may transmit the third capture from the hard drive 126 to another network diagnostic component for further analysis.

### Exemplary Multi-Tier Networking System

As shown in FIG. 2, the networking system 100 may include a plurality of distinct tiers of functional components, including a data source tier 182, a portal tier 184, and a client tier 186.

The data source tier 182 preferably comprises a plurality of network diagnostic components 102. The network diagnostic components 102 may generate network activity data 104, for example, as discussed above with reference to the blocks 134, 140, 150, 160, 166, 176.

The portal tier 184 may collect, manage and/or reformat the network activity data 104 generated by the network diagnostic components 102 of the data source tier 182. In addition, the portal tier 184 may aggregate the network diagnostic data 104 from two or more network diagnostic components 102. The portal tier 184 is preferably implemented in a software or firmware based module executing within a programmable device, such as a host computer.

The client tier 186 preferably comprises software implemented clients that may provide visualizations of the network activity data 104 generated by the network diagnostic components. In addition, the client tier 186 may be used to configure the function of the portal tier 184.

In one embodiment, the portal tier 184 may aggregate the network diagnostic data 104 using the network configuration data 106. In particular, the portal tier 184 may access the network configuration data 106, and the portal tier 184 may use that network configuration data 106 to identify a set of components of the networking system 100. The portal tier 184 may then aggregate the network diagnostic data 104 for the set of components. For example, the portal tier 184 may use the network configuration data 106 to identify a plurality of links 128 through which a particular node (such as a storage device) sends and receives network messages. Accordingly, the portal tier 184 may collect network activity data 104 from network diagnostic components 102 receiving network messages from those links, and the portal tier 184 may aggregate network activity data 104 for the node. For example, the portal tier 184 may average statistics calculated for the links, may sum statistics calculated for the links, and/or may perform other suitable operations to aggregate those statistics. Other suitable methods for aggregating network activity data and for using network configuration data are disclosed in Assignee's U.S. patent application Ser. No. ______, filed May 12, 2006 and entitled NETWORK DIAGNOSTIC SYSTEMS AND METHODS FOR USING NETWORK CONFIGURATION DATA (Attorney Docket No. 15436.805), which is hereby incorporated by reference herein.

It will be appreciated that the networking system 100 does not require a plurality of distinct tiers of functional components and that the networking system 100 does not require a data source tier, a portal tier, or a client tier.

### Exemplary Trigger Method

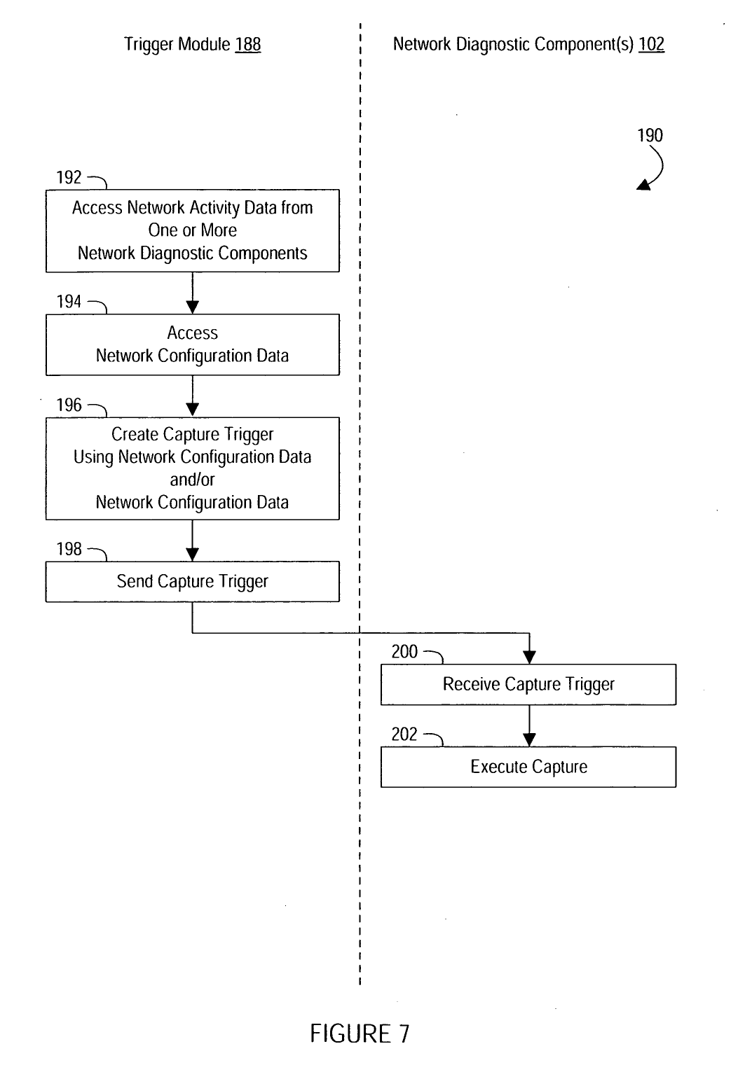

As shown in FIG. 2, the portal tier 188 may include a trigger module 188. As shown in FIG. 7, the trigger module 188 may trigger one or more network diagnostic components to each execute one or more captures.

In further detail, the trigger module 188 and/or at least one network diagnostic component 102 preferably may perform some or all of a network diagnostic method 190; however, some or all of the method 190 may be performed by the trigger module 188; at least one network diagnostic component 102; one or more other suitable modules, systems, and the like; or any suitable combination of one or more thereof. Of course, the entire method 190 need not be performed; and any part or parts of the method 190 may be performed to provide a useful method 190.

As shown in FIG. 7, the trigger module 188 of the portal tier 184 may access network activity data 104 from one, two, three or more network diagnostic components 102 at a block 192, and the trigger module 188 may access network configuration data 106 at a block 194. At a block 196, the trigger module 188 may create a capture trigger using the network configuration data 194 that was accessed at the block 194 and/or the network activity data 104 that was accessed at the block 192. Thus, the trigger module 188 may be configured to create a capture trigger in response to detecting a variety of conditions indicated by the network diagnostic data 104 and/or by the network configuration data 106. At a block 198, the trigger module 188 many send the capture trigger to one, two, three or more network diagnostic components 102, which may receive the capture trigger at the block 200 and, in response to receiving the capture trigger, execute a capture at the block 202 (for example, as shown in FIGS. 3-6).

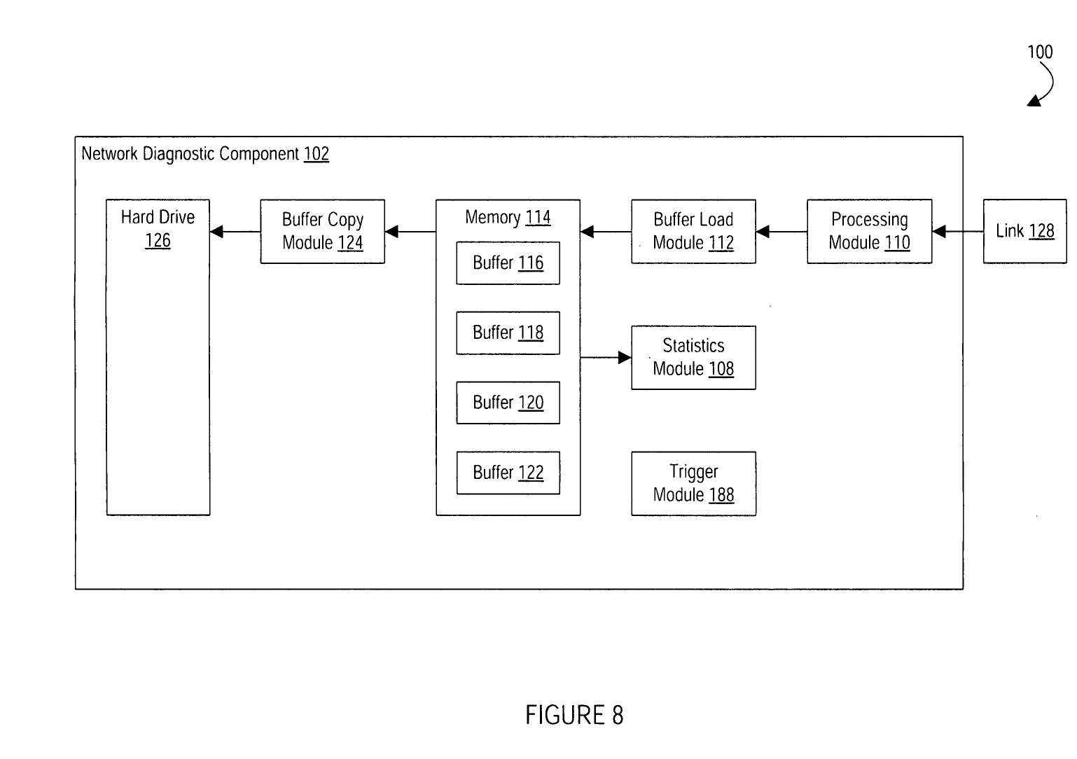

As shown in FIG. 8, the network diagnostic module 102 may advantageously include a trigger module 188, if desired. Accordingly, the trigger module 188 of the network diagnostic module 102 may perform the blocks 192, 194, 196, 198 of the method 190, if desired.

### Exemplary Trigger Conditions

As mentioned above, a trigger module 188 may be configured to create a capture trigger in response to detecting a variety of conditions indicated by the network diagnostic data 104 and/or by the network configuration data 106.

In one configuration, in response to detecting a particular condition of a first component of the networking system 100, the trigger module 188 may create and send a capture trigger to one or more network diagnostic modules 102 coupled to at least one link 128 associated with that component and/or one or more network diagnostic modules 102 coupled to other links 128.

In one configuration, in response to detecting a particular condition among a plurality of components of the networking system 100, the trigger module 188 may create and send a capture trigger to one or more network diagnostic modules 102 coupled to some or all of a plurality of links 128 associated with those components and/or one or more network diagnostic modules 102 coupled to other links 128.

In one configuration, in response to detecting a particular condition on a first link 128, the trigger module 188 may create and send a capture trigger to a network diagnostic module 102 coupled to the first link 128 and/or one or more network diagnostic modules 102 coupled to other links 128.

In one configuration, in response to detecting a particular statistic calculated using a plurality of links 128, the trigger module 188 may create and send a capture trigger to one or more network diagnostic modules 102 coupled to some or all of the plurality of links 128 and/or one or more network diagnostic modules 102 coupled to other links.

In one configuration, in response to detecting an exchange completion time that is at or above particular value (or is otherwise outside a particular range of values) on a link 128, the trigger module 188 may create a capture trigger and may send it to a network diagnostic component 102 coupled to the link 128.

In one configuration, in response to detecting latency that is at or above a particular value (or is otherwise outside a particular range of values) on a link 128, the trigger module 188 may create a capture trigger and may send it to a network diagnostic component 102 coupled to the link 128.

In one configuration, in response to detecting an exchange completion time and/or latency that are repeatedly at or above particular values (or otherwise outside particular ranges of values) at a particular time of day on a link 128, the trigger module 188 may, at that particular time of day, create and send a capture trigger to a network diagnostic component 102 coupled to the link 128.

In one configuration, in response to detecting a particular condition on a first link 128, the trigger module 188 may create and send a capture trigger to a first network diagnostic module 102 coupled to the first link 128 and/or to one or more network diagnostic modules 102 coupled to one or more links 128 related to the first link. For example, in response to detecting one or more exchange completion times that are at or above particular value (or are otherwise outside a particular range of values) on a first link 128, the trigger module 188 may create and send a capture trigger to a first network diagnostic module 102 coupled to the first link 128 and/or to one or more network diagnostic modules 102 coupled to one or more links 128 related to the first link. The first link 128 and the one or more related links 128 may be related, for example, because they represent alternate paths to the same node, such as the same server.

In one configuration, the trigger module 188 may create a capture trigger in response to detecting a plurality of a particular type of network message (such as, aborts) in a particular amount of time.

In one configuration, the trigger module 188 may create a capture trigger in response to detecting a plurality of a particular type of errors (such as, CRC errors) in a particular amount of time.

In one configuration, the trigger module 188 may create a capture trigger in response to detecting a plurality of a particular type of events (such as, logins or logouts) in a particular amount of time.

In one configuration, the trigger module 188 may create a capture trigger in response to detecting the alteration of the network configuration data. For example, in response to detecting the alteration of a switch's zone, the trigger module 188 may create a capture trigger to capture before and after the alteration. Also, for example, in response to detecting a LUN mapping change, the trigger module 188 may create a capture trigger to capture before and after the change. Also, for example, in response to detecting a node replacement (such as, a server replacement), the trigger module 188 may create a capture trigger to capture before and after the replacement.

In one configuration, the trigger module 188 may create a capture trigger in response to detecting latency that is at or above a particular value (or is otherwise outside a particular range of values) on a DWDM WAN. For example, in response to detecting latency that is at or above a particular value (or is otherwise outside a particular range of values) on a DWDM WAN, the trigger module 188 may create a capture trigger to capture buffer-to-buffer credits.

If desired, the trigger module 188 may create a capture trigger in response to detecting any other suitable condition or conditions, including but not limited to, any statistic that is outside a particular range of values and/or any change in network configuration data 106 associated with the networking system 100. The particular range of values may be, for example, baselines. Suitable aspects, systems and methods that may be used for creating baselines are disclosed in Assignee's U.S. patent application Ser. No. ______, filed May 12, 2006 and entitled NETWORK DIAGNOSTIC SYSTEMS AND METHODS FOR USING NETWORK CONFIGURATION DATA (Attorney Docket No. 15436.805).

Other suitable aspects, systems and methods that may be used in connection with the networking system 100 are disclosed in Assignee's U.S. patent application Ser. No. ______, filed May 12, 2006 and entitled NETWORK DIAGNOSTIC SYSTEMS AND METHODS FOR USING NETWORK CONFIGURATION DATA (Attorney Docket No. 15436.805).

### Exemplary Operating and Computing Environments

The methods and systems described above can be implemented using software, hardware, or both hardware and software. For example, the software may advantageously be configured to reside on an addressable storage medium and be configured to execute on one or more processors. Thus, software, hardware, or both may include, by way of example, any suitable module, such as software components, object-oriented software components, class components and task components, processes, functions, attributes, procedures, subroutines, segments of program code, drivers, firmware, microcode, circuitry, data, databases, data structures, tables, arrays, variables, field programmable gate arrays (“FPGA”), a field programmable logic arrays (“FPLAs”), a programmable logic array (“PLAs”), any programmable logic device, application-specific integrated circuits (“ASICs”), controllers, computers, and firmware to implement those methods and systems described above. The functionality provided for in the software, hardware, or both may be combined into fewer components or further separated into additional components. Additionally, the components may advantageously be implemented to execute on one or more computing devices. As used herein, “computing device” is a broad term and is used in its ordinary meaning and includes, but is not limited to, devices such as, personal computers, desktop computers, laptop computers, palmtop computers, a general purpose computer, a special purpose computer, mobile telephones, personal digital assistants (PDAs), Internet terminals, multi-processor systems, hand-held computing devices, portable computing devices, microprocessor-based consumer electronics, programmable consumer electronics, network PCs, minicomputers, mainframe computers, computing devices that may generate data, computing devices that may have the need for storing data, and the like.

Also, one or more software modules, one or more hardware modules, or both may comprise a means for performing some or all of any of the methods described herein. Further, one or more software modules, one or more hardware modules, or both may comprise a means for implementing any other functionality or features described herein.

Embodiments within the scope of the present invention also include computer-readable media for carrying or having computer-executable instructions or data structures stored thereon. Such computer-readable media can be any available media that can be accessed by a computing device. By way of example, and not limitation, such computer-readable media can comprise any storage device or any other medium which can be used to carry or store desired program code means in the form of computer-executable instructions or data structures and which can be accessed by a computing device.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a computing device to perform a certain function or group of functions. Data structures include, for example, data frames, data packets, or other defined or formatted sets of data having fields that contain information that facilitates the performance of useful methods and operations. Computer-executable instructions and data structures can be stored or transmitted on computer-readable media, including the examples presented above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A network diagnostic system comprising:
a network diagnostic component comprising:
a first buffer;
a second buffer;
a storage device;
a buffer load module configured to store at least a portion of a plurality of network messages in the first buffer; the buffer load module being configured to, in response to a first capture trigger, cease storing at least a portion of a plurality of network messages in the first buffer and commence storing at least a portion of a plurality of network messages in the second buffer; and
a buffer copy module configured to, in response to the first capture trigger, copy the at least a portion of a plurality of messages in the first buffer to the storage device.

2. The network diagnostic system as in claim 1, wherein the buffer load module is further configured to, in response to a second capture trigger, cease storing at least a portion of a plurality of network messages in the second buffer and commence storing at least a portion of a plurality of network messages in the first buffer.

3. The network diagnostic system as in claim 2, wherein the buffer copy module is further configured to, in response to the second capture trigger, copy the at least a portion of a plurality of messages in the second buffer to the storage device.

4. The network diagnostic system as in claim 1, wherein the first buffer is a circular buffer; and wherein the second buffer is a circular buffer.

5. The network diagnostic system as in claim 1, wherein the network diagnostic component further comprises a processing module configured to process network messages and to send the processed network messages to the buffer load module.

6. The network diagnostic system as in claim 1, wherein the network diagnostic component further comprises a statistics module configured to generate network activity data using at least a portion of the contents of the first buffer, the second buffer, or both the first buffer and the second buffer.

7. The network diagnostic system as in claim 1, further comprising a trigger module configured to, in response to detecting a condition, provide the first capture trigger.

8. The network diagnostic system as in claim 7, wherein the condition comprises a change in network configuration data associated with a networking system.

9. The network diagnostic system as in claim 7, wherein the condition comprises network activity data being outside a particular range of values.

10. The network diagnostic system as in claim 1, wherein the storage device comprises a hard drive.

11. A network diagnostic system comprising:
a network diagnostic component comprising:
a first buffer;
a second buffer;
a third buffer;
a storage device;
a buffer load module configured to store at least a portion of a first plurality of network messages in the first buffer and to store the at least a portion of a first plurality of network messages in the second buffer;
the buffer load module being configured to, in response to a first capture trigger, to store at least a portion of a second plurality of network messages in the first buffer and to store the at least a portion of a second plurality of network messages in the third buffer; and
a buffer copy module configured to, in response to the first capture trigger, copy the at least a portion of a plurality of messages in the second buffer to the storage device.

12. The network diagnostic system as in claim 11, wherein the buffer load module is further configured to, in response to a second capture trigger, to store at least a portion of a third plurality of network messages in the first buffer and to store the at least a portion of a third plurality of network messages in the second buffer.

13. The network diagnostic system as in claim 12, wherein the buffer copy module is further configured to, in response to the second capture trigger, copy the at least a portion of a second plurality of messages in the third buffer to the storage device.

14. The network diagnostic system as in claim 11, wherein the first buffer is a circular buffer; wherein the second buffer is a circular buffer; and wherein the third buffer is a circular buffer.

15. The network diagnostic system as in claim 11, wherein the network diagnostic component further comprises a processing module configured to process network messages and to send the processed network messages to the buffer load module.

16. The network diagnostic system as in claim 11, wherein the network diagnostic component further comprises a statistics module configured to generate network activity data using at least a portion of the contents of the first buffer.

17. The network diagnostic system as in claim 11, further comprising a trigger module configured to, in response to detecting a condition, provide the first capture trigger.

18. The network diagnostic system as in claim 17, wherein the condition comprises a change in network configuration data associated with a networking system.

19. The network diagnostic system as in claim 17, wherein the condition comprises network activity data being outside a particular range of values.

20. The network diagnostic system as in claim 11, wherein the storage device comprises a hard drive.

21. A network diagnostic system comprising:
a network diagnostic component configured to, in response to a capture trigger, execute a capture of at least a portion of one or more network messages; and
a trigger module configured to, in response to detecting a change in network configuration data associated with a networking system, provide the trigger.

22. A network diagnostic system comprising:
a network diagnostic component comprising:
a first buffer;
a second buffer;
a third buffer;
a storage device;
a buffer load module configured to store at least a portion of a first plurality of network messages of a first type in the first buffer, to store the at least a portion of a first plurality of network messages of a first type in the second buffer, and to store at least a portion of a first plurality of network messages of a second type in the second buffer;
the buffer load module being configured to, in response to a first capture trigger, to store at least a portion of a second plurality of network messages of the first type in the first buffer, to store the at least a portion of a second plurality of network messages of the first type in the third buffer, and to store at least a portion of a second plurality of network messages of the second type in the third buffer; and
a buffer copy module configured to, in response to the first capture trigger, copy the at least a portion of a plurality of messages in the second buffer to the storage device.
